(19) United States
(12) Patent Application Publication
(10) Pub. No.: US 2007/0043829 A1
(43) Pub. Date: Feb. 22, 2007

(54) Method and system for accessing a storage or computing device via the Internet

(76) Inventor: Robin Dua, Vienna, VA (US)

Correspondence Address: Charles B. Lobsenz;Roberts, Mlotkowski & Hobbes, PC, Suite 850, 8270 Greensboro Drive, McLean, VA, 22102, US

(21) Appl. No.: 11/205,639

(22) Filed: Aug. 17, 2005

(51) Int. Cl. G06F 15/16

(52) U.S. Cl. 709/219

(57) ABSTRACT

A system and method for accessing a storage or computing device via the Internet using a Domain Name System (DNS)-based infrastructure is disclosed. One aspect of the methodology pertains to registering a storage device with a SIP registration server and associating it with an E.164 phone number. In one embodiment, a media device uses an ENUM engine to translate an E.164 number associated with a target storage device into a routable Internet address by using a Domain Name System (DNS)-based infrastructure. The routable Internet address is further used to establish real-time communication between the media device and the target device.

### BACKGROUND

1. Field of the Invention

The present invention relates generally to systems and methodologies for accessing a storage or computing device via the Internet and more particularly to systems and methodologies for using a Domain Name System (DNS)-based infrastructure for doing so.

2. Background of the Invention

The consumer electronics market is exploding. The continued miniaturization of electronic components, enhanced processing power of chips, and reduced manufacturing costs has contributed to the proliferation of consumer electronic devices capable of processing digital media such as audio, video, images, animation, presentations, and other content. Media devices include for example, cellular phones, personal digital assistants (PDAs), MP3 players, video players, camcorders, game players, digital cameras, digital video recorders (DVRs), personal computers, stereos, etc. Many media devices are able to store large amounts of digital content, connect to the Internet, and in some instances wirelessly exchange data over short ranges with other electronic devices. The proliferation of devices capable of playing and recording digital media has resulted in large volumes of content within the household and workplace that is distributed across devices.

It is often desirable to interact on a frequent basis with multiple electronic devices that contain different types of digital media. For example, users might have digital music stored in a pocket-size MP3 player, photos stored in a cellular phone, video stored on a personal computer, or a variety of other digital media stored on other portable electronic devices within their homes or offices. The standardization of file formats across devices for a variety of media types and the availability of processing support for these media types has allowed users to transfer and share digital information between devices and with other Internet users more readily.

A problem remains in that when users are not in possession of one or more of their electronic devices, gaining access to their digital content remotely is not always easy or possible. The use of Internet-based storage services offered by a number of providers allows users to centrally store digital content in the provider's storage systems and access it from computing devices connected to the Internet. Such services typically require users to first establish a storage account with the provider. Once an account has been established, the user can login to the provider's web site with a valid username and password in order to upload, download, or otherwise access stored media assets. Internet-based storage services typically pose a limitation in that media assets can only be uploaded, downloaded, or accessed by using a web browser or other proprietary application. As such, certain media devices (e.g., stereos, MP3 players, etc.) that are incapable of running web browsers or other required applications can not be used directly with Internet storage services as described.

The use of privately-owned network storage systems to centrally store digital media is also growing in popularity. Commercially available storage units can be connected to home or office networks as a way to locally store media content and also provide remote access to that data. While such storage systems offer consumers greater control over their data, the methods by which these devices provide remote connectivity to data via the Internet have several drawbacks.

Many residential and small business users connect to the Internet using broadband service offered over cable or Digital Subscriber Line (DSL). Cable companies and telecom operators typically employ the use of Dynamic Host Configuration Protocol (DHCP) to dynamically assign an Internet Protocol (IP) address, subnet mask, gateway (or router address) and Domain Name System (DNS) addresses to routers or modems connecting to their respective networks. Many of these modems and routers also function as switches, allowing users to directly connect computers, printers, storage systems, and other network devices via available Ethernet ports. The modem/router in turn functions as a DHCP server for the user's network. Network devices can be plugged directly into the modem/router which in turn assigns them non-routable IP addresses, subnet, gateway and DNS information via DHCP and directs traffic to and from the devices with Network Address Translation (NAT). This setup keeps home or office network traffic private, and still allows connections to the Internet as needed. These modems/routers also function as firewalls, protecting a user's internal network from unauthorized access and other external threats.

NAT is most commonly used to enable multiple hosts on a private network to access the Internet using a single public IP address. In this case, one routable IP address is dynamically assigned to the modem/router by the Internet Service Provider (ISP). Devices behind a NAT-enabled modem/router do not have true end-to-end connectivity and cannot participate in some Internet protocols. Services that require the initiation of Transmission Control Protocol (TCP) connections from the outside network, or stateless protocols such as those using User Datagram Protocol (UDP), can be disrupted. Unless the NAT router makes a specific effort to support such protocols, incoming packets cannot reach their destination. Some protocols can accommodate one instance of NAT between participating hosts (“passive mode” File Transfer Protocol (FTP), for example) sometimes with the assistance of an Application Layer Gateway, but fail when both systems are separated from the Internet by NAT. It also complicates security protocols such as Internet Protocol Security (IPsec). As a result of the above, in the typical home or small business setup employing NAT it is difficult, if not impossible, to access storage devices remotely via the Internet.

Some network storage devices come bundled with a service whereby a user can setup a web account to remotely access content on their personal storage device via the Internet. The “web access” feature must be enabled on the personal storage device and a web account must be established through the hardware vendor's web site. This allows the personal storage device on the user's network to establish a connection with the vendor's communication servers using, for example, Hypertext Transport Protocol (HTTP) over Secure Socket Layer (SSL). Some devices generate only outgoing HTTP/TCP connections to ports 80, 443 and/or 8200. Because most firewalls are already configured to permit outgoing Web traffic, users do not have to bypass or compromise their firewall to implement secure remote access. Such storage devices send an outgoing HTTP “ping” to the vendor's communications server at regular intervals, checking to see if any connection requests have been received. This makes such solutions compatible with application proxy firewalls, dynamic IP addresses and network/port address translation (NAT/PAT).

When the user logs into the vendor's web site using a standard web browser, the user is authenticated, and the contents of the personal storage device are displayed. The user can in turn access media assets stored on the device or upload content to it using the web browser. This design has the benefit of allowing the personal storage device to use a non-routable IP address that may be assigned to it via DHCP. Since the storage unit establishes a connection with the vendor's systems, the user has complete access to media assets contained in the personal storage system via a standard web browser. While this type of product and service combination provides users with remote access to their media assets via the Internet, the user is limited to accessing the personal storage device through a web browser or other proprietary application provided by the hardware vendor. The user is also required to authenticate himself through the storage vendor's web site, which may also present challenges if the user desires to access his content using a non-supported device.

In some cases, a static IP address can be assigned to a storage device allowing a user to directly connect to the storage system from other devices on the Internet. Static IP addresses are difficult to remember and must be configured in the storage system—making this option less user friendly for users. A domain name (e.g., “mydomain.com”) can be mapped in a DNS server to an IP address that is assigned to a storage device, allowing the user to connect to the storage system using the more memorable domain name address. Registering a domain name and mapping the domain or a sub-domain (e.g., “storage.mydomain.com”) to the storage device may not always be possible through the user's ISP. If it is possible, the user is likely to pay additional fees and will also be required to configure the storage device with the appropriate network information. While network administrators in a corporate environment may not have any difficulty setting up a network storage device and configuring it with an assigned IP address and domain name, these are much more demanding tasks for the typical user to undertake.

Web-based storage services offered by various service providers as well as current network storage devices present a variety of drawbacks as discussed above. One primary hurdle to the use of such solutions is that they limit the user to accessing stored content through a web browser or proprietary application as they were primarily designed for use with personal computers. Such solutions generally require the user to access their stored content through an intermediary server. Direct access to a personal storage device is possible by using a static IP address or mapped domain name, but such options are generally difficult to configure, are time consuming, and result in additional fees for the user.

Accordingly, there is a need for a storage solution which easily connects to any home or business network and allows direct access to that storage device over the Internet using an address scheme that is user friendly and easy to set up and use. There is also a need for a storage solution that can be accessed by a variety of wireline and wireless devices, including those that do not run web browsers, have reduced or non-existent display screens, and have limited data input capability. There is also a need for a system and method through which users can rapidly access and remotely manage a computing device via the Internet using an address scheme that is user friendly and robust.

### SUMMARY OF THE INVENTION

It is therefore a primary object of the present invention to provide a system and methodology which improves upon prior art systems and methodologies and their related drawbacks as described above.

It is another object of the present invention to provide a system and methodology for accessing storage which is easily implemented with any home or business network and allows direct access to a storage device over the Internet.

It is another object of the present invention to provide a system and method through which users can rapidly target a specific storage or computing device connected to the Internet via an easy to use address scheme.

It is a yet further object of the present invention to provide for the convenient, efficient, and secure access to storage and computing systems via the Internet such that only those authorized to connect to the storage or computing system may do so and only to the extent of their authorization.

It is a yet further object of the present invention to provide a system whereby a multiplicity of wireline and wireless devices can connect to a storage or computing device via the Internet using an easy to use address scheme.

These and other objects of the present invention are obtained through the use of a novel system and methodology employing the Domain Name System and existing Voice-over-IP (VOIP) infrastructure of service providers to provide connectivity to storage and computing devices over the Internet. According to the teachings of the invention, storage and other computing devices can be accessed via wireless or wireline networks with a wide variety of electronic devices.

These and other advantages and features of the present invention are described herein with specificity so as to make the present invention understandable to one of ordinary skill in the art.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a functional diagram of various media player devices connected to a target storage device via the Internet, in accordance with one embodiment of the present invention;

FIG. 2 is a flowchart illustrating the steps in the process of a storage device registering itself with a service provider's registrar server according to a preferred embodiment of the present invention;

FIG. 3 is a representation of a hardware interface for a media player device or its remote control according to a preferred embodiment of the present invention;

FIG. 4 is a flowchart illustrating the steps in the process of accessing a storage device from a media player device via the Internet according to a preferred embodiment of the present invention;

FIG. 5 is a functional diagram of a wireless media player device connected to a target storage device via the Internet in accordance with one embodiment of the present invention; and

FIG. 6 is a flowchart illustrating the steps in the process of a remote access application operating on a computing device.

### DETAILED DESCRIPTION OF THE INVENTION

The present invention for remote Internet-based storage and computing access is now described in specific terms sufficient to teach one of skill in the practice the invention herein. In the description that follows, numerous specific details are set forth by way of example for the purposes of explanation and in furtherance of teaching one of skill in the art to practice the invention. It will, however, be understood that the invention is not limited to the specific embodiments disclosed and discussed herein and that the invention can be practiced without such specific details and/or substitutes therefor. The present invention is limited only by the appended claims and may include various other embodiments which are not particularly described herein but which remain within the scope and spirit of the present invention.

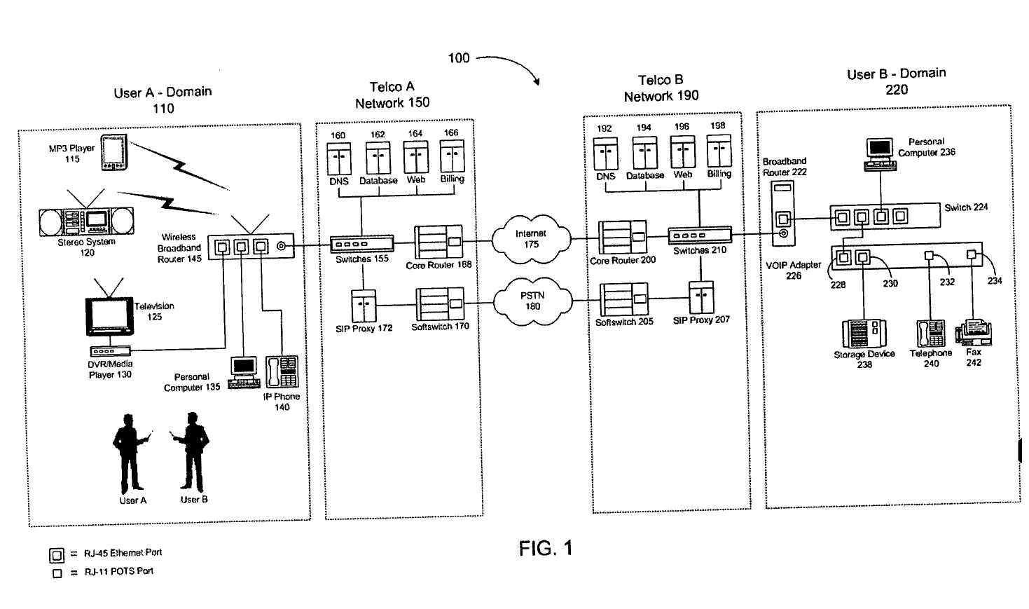

A general discussion of the present invention is now provided and is thereafter followed by a detailed description of each of the components and functions of the invention according to specific preferred embodiments. FIG. 1 is an overall network diagram illustrating some of the key components of the Internet storage access system of the present invention in a preferred embodiment thereof. The ultimate goal of the present invention is to allow for the secure and rapid access to a remote storage device by one or more Internet connected media devices. As used herein, a storage device, as the name implies, is a device for storing electronic data. The storage device has read/write functionality and allows for data to be retained in a non-volatile memory component. The storage device can use any number of technologies capable of holding encoded information such as flash memory/memory cards, magnetic bubble memory, and disk storage (e.g., optical, magnetic, holographic, etc.). The storage device as contemplated herein directly connects to a local area network using Ethernet or other wireline or wireless connection interface options. The storage device may additionally have its own operating system, software, processing capability, volatile memory component, and allow for remote administration and configuration via a web-based, command-line, or other interface.

Examples of commercially available network storage devices like the one described herein are the EFG120 from Linksys or the StorEdge 3120 from Sun Microsystems, Inc. In an alternate embodiment, the storage device could be a network Digital Video Recorder (DVR)/media device with an integrated storage component that allows for television programming and other content to be digitally recorded, accessed, and played. Examples of DVR/media player devices include TiVo (TiVo Inc.), ReplayTV (Digital Networks North America, Inc.), MediaLounge DSM-320 Wireless Media Player (D-Link Corporation), and various Microsoft XP Media Center-based systems. It is contemplated herein that all aforementioned and similar storage devices could be modified to incorporate some or all elements of the present invention.

It should be noted that the diagram illustrated in FIG. 1 and described herein is meant to show one possible network configuration. In practice, network components and configurations can be altered while still remaining within the scope and spirit of the present invention.

To help illustrate the invention, FIG. 1 depicts a scenario where User B has left his home (User B—Domain 220) and is visiting User A in his home (User A—Domain 110). User A has various media player devices connected to a wireless broadband router 145. The wireless broadband router 145 also functions as a switch, and allows various devices to directly connect to it via its Ethernet ports or through its wireless interface (e.g., 802.11G). An example of a commercially available wireless router like the one described herein is the WRT54G from Linksys (a division of Cisco Systems, Inc.). Connected to the router 145 is a wireless MP3 player 115 (which may be, for example, an Apple iPod device), wireless stereo system 120, a DVR/media device 130, a personal computer 135, and an Internet Protocol (IP) phone 140. The router 145 in turn interfaces with User A's Internet Service Provider (ISP) via a direct connection to Telco A's switch 155. User A's router obtains its IP address and other network settings via a DHCP server on Telco A's network 150. The broadband router 145 in turn also functions as a DHCP server for User A's network, assigning non-routable addresses to each of the connected devices and using NAT to route traffic to the devices and out to the Internet 175.

In the scenario depicted in FIG. 1, User B desires to show User A a number of media assets that are stored in his personal storage device 238 connected to his home network and accessible via the Internet. The invention allows User B to use any of the media player devices represented in User A's domain 110 to access his network storage device 238 remotely. According to a preferred embodiment of the invention, User B would enter his primary E.164 phone number associated with his storage device into any one of User A's media player devices. As an example, User B could use the wireless stereo system 120 or the wireless MP3 player 115 to access music stored on his storage device 238, the DVR/media device 130 (connected to the television 125) to access videos that are contained in his storage device 238, or the personal computer 135 to download documents from the storage device 238.

In order to explain how the respective media devices access the storage device 238 over the Internet 175 using User B's E.164 phone number, an overview of User B's network 220 is provided herein. First, User B has a broadband router 222 which is connected to a switch 210 on telco B's network 190. It is through this interface that User B's network 220 has access to the Internet 175. An example of a commercially available cable/DSL router 222 like the one described herein is the BEFSR11 from Linksys (a division of Cisco Systems, Inc.). User B's router 222 is also connected to a 10/100/1000 Mbps auto-sensing Ethernet switch 224 on User B's network. An example of a commercially available Ethernet switch like the one described herein is the PC22604 from Linksys. Connected to the Gigabit Ethernet switch 224 is a personal computer 236 and a voice-over-IP (VOIP) adapter 226 (sometimes referred to as an analog telephone adapter or an ATA for short). The VOIP adapter depicted in FIG. 1 has one uplink Ethernet port 228 that allows the adapter to connect to the switch 224, one additional Ethernet port 230 for a network storage device, and two RJ-11 Plain Old Telephone Service (POTS) ports represented as 232 and 234. The POTS ports can be used to connect an analog device such as a telephone 240 or fax machine 242.

The broadband router 222 in User B's network uses DHCP to assign non-routable IP addresses to all devices connected to it. In an alternative embodiment, static IP addresses can be assigned to devices on the network.

The VOIP adapter 226 communicates with a SIP Proxy Server 207 on Telco B's network 190. The VOIP adapter 226 and Telco B's SIP Proxy Server 207 use the Session Initiation Protocol (SIP) to enable VOIP and other multimedia services. SIP (RFC 3261) is a text-based application protocol that allows two endpoints in the Internet to discover one another in order to exchange context information about a session they would like to share. SIP is an application-layer control protocol that can establish, modify, and terminate multimedia sessions such as Internet telephony calls. SIP can also be used to invite participants to already existing sessions such as multicast conferences. SIP transparently supports name mapping and redirection services, which allows for personal mobility; users can maintain a single externally visible identifier regardless of their network location.

The SIP Proxy Server 207 on Telco B's network 190 provides the functionality of a SIP proxy, SIP redirect, SIP registrar, and SIP location services server. The SIP Proxy Server 207 provides the foundation for call routing within SIP networks. It can interface with traditional SIP location services such as DNS or Electronic Numbering (ENUM), with feature servers (e.g., for voice mail, auto attendant, etc.), and with H.323 location services using standard Location Request (LRQ) messages. Cisco Systems, Inc. (San Jose, Calif.) makes a SIP proxy server similar to the one described herein.

The SIP Proxy Server 207 interfaces with a softswitch 205 on Telco B's network. The softswitch 205 provides call management functionality to Class 4 and Class 5 networks, and provides SIP-to-Signaling System 7 (SS7) gateway functionality for American National Standards Institute (ANSI) standardized networks. The softswitch 205 supports SIP user-agent functionality in conjunction with a packet voice media gateway. An example of a softswitch 205 is the BTS 10200 Softswitch from Cisco Systems, Inc.

The network illustrated in FIG. 1 and described herein is typical of how SIP-based VOIP networks are architected. These networks employ SIP for call signaling between the carrier's network and the customer's VOIP adapter 226. As is common in these networks, the VOIP adapter 226 maintains a registration with a SIP registrar 207 on the provider's network 190. A SIP registrar 207 is a device that stores the logical location of user agents within that domain or subdomain. A SIP registrar server 207 stores the location of user agents and dynamically updates its data via REGISTER messages. Registration of the VOIP adapter 226 with the SIP registrar 207 allows the adapter to terminate and originate a SIP session. For example, calls to User B's E.164 phone number which originate over the Public Switched Telephone Network (PSTN) 180 or Internet 175 can be routed to the VOIP adapter 226 so the call can be answered using the analog phone 240 connected to it.

Currently VOIP providers must maintain an interface to the circuit-switched PSTN 180 in order to route calls to and from other carriers. As all circuit-switched traffic migrates to packet networks such as the Internet 175 in the future, the need to maintain a PSTN interface will be eliminated. In the future, Electronic Numbering (ENUM) will also be used to resolve a fully qualified E.164 telephone number for a particular wireline or wireless device to a fully qualified domain name address using a DNS-based architecture. ENUM (RFC 3761) is the Internet Engineering Task Force (IETF) standard that defines a mechanism for using the Domain Name Service (DNS) as a tool to “discover” services associated with a telephone number (E.164 number).

VOIP adapters utilize SIP for call signaling and support numerous SIP extensions and methods. Common VOIP adapters for residential and small office networks have 2 Ethernet ports—one for connecting to a broadband modem and one for connecting to a PC or a hub. They typically offer essential routing features—including Routing with Network Address Port Translation (NAPT) and support for Virtual Private Network pass-through. Common adapters also offer STUN (Simple Traversal of UDP Through NAT), TURN (Traversal Using Relay NAT), RSIP (Realm Specific IP) and outbound proxy support for NAT traversal. Other NAT traversal techniques are expected to be supported by VOIP adapters in the future; one such technique includes the Interactive Connectivity Establishment (ICE), developed by the IETF's MMUSIC working group. ICE provides a framework to unify the various NAT traversal techniques. This enables SIP-based VOIP clients to successfully traverse the variety of firewalls that may exist between a remote user and a network. Many VOIP adapters support up to 2 lines for Voice-over-IP (VOIP) phone or fax service. The units come with standard RJ-11 POTS ports allowing analog phones and fax machines to be connected. The units also generally prioritize telephone calls over Internet traffic so customers enjoy clear voice quality comparable to analog voice service over a circuit-switched network. Many units also offer rich CLASS features for enhanced telephony services such as caller ID, call waiting, three way calling, etc. VOIP adapters are generally plug-and-play devices with the carrier's network settings pre-programmed making VOIP setup easy for residential users.

Examples of VOIP adapters offered commercially include the VT1000 Voice Terminal, VT2000 Voice Gateway, VT2400 Advanced Voice Gateway, and VT2500 Wireless Voice Gateway manufactured by Motorola, Inc. (Schaumburg, Ill.). Similar VOIP adapters are manufactured by Cisco Systems, Inc. (San Jose, Calif.) and D-Link Corporation (Fountain Valley, Calif.).

The use of a Session Border Controller (SBC) is also possible on certain VOIP networks as a way to address the NAT traversal and firewall penetration issues discussed earlier.

According to one embodiment of this invention, VOIP adapters as described herein and commercially available would be modified to automatically detect a network storage device that is plugged directly into an available data port in the adapter. An illustration of a VOIP adapter 226 with a network storage device 238 connected to its Ethernet port 230 is shown in FIG. 1.

According to a preferred embodiment of the invention, a storage device 238 connected to a functioning VOIP adapter 226 would be automatically registered with a SIP registrar 207 on the service provider's network 190. Such registration would activate an ENUM-based storage service for the user. Electronic Numbering (ENUM) is a suite of protocols to unify the telephone system with the Internet by using E.164 addresses with DNS. According to the invention, the user would in turn be able to access his storage system remotely over the Internet from supported media player devices using his assigned E.164 number.

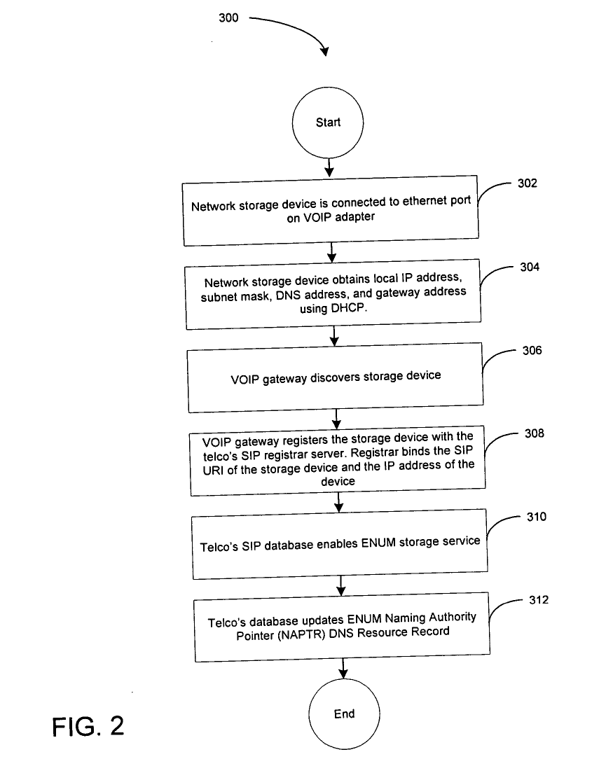

FIG. 2 is a flowchart illustrating the steps in the process of a storage device registering itself with a service provider's SIP registrar server according to a preferred embodiment of the present invention. In step 302, the network storage device 238 is first connected to the VOIP adapter's 226 Ethernet port 230. In practice any type of device interface could be used to connect the devices while still remaining within the scope and spirit of the present invention. In step 304, the network storage device 238 obtains an IP address, subnet mask, DNS address, and gateway address via DHCP. In step 306, the VOIP adapter 226 “discovers” the storage device using Universal Plug and Play (UPnP™) technology.

UPnP™ standards are promulgated by the UPnP™ Forum (http://www.upnp.org), an industry group working to enable simple and robust connectivity among stand-alone devices and PCs from many different vendors. With UPnP™, a device can automatically join a network, obtain network settings, inform other devices on the network about its existence and capabilities, and learn about other network devices. When such a device has exchanged its data or goes outside the network area (in the case of wireless devices), it can leave the network cleanly without interrupting any of the other devices.

The ultimate goal is to allow data communication among all UPnP™ devices regardless of media, operating system, programming language, and wired/wireless connection. To foster such interoperability, UPnP™ relies on network-related technologies built upon industry-standard protocols such as HTTP, IP, TCP, UDP, and XML. Because devices and their corresponding services can vary so dramatically, there are numerous UPnP™ industry groups actively working to standardize the services supported by each device class.

In the current example, when a storage device is added to a UPnP™ network, its first step is to obtain an IP address. Once this is accomplished via its internal DHCP client, the device advertises its presence, providing a description of itself and its services. A control point receives the description, which includes a list of actions related to each service and the variables that define the possible states for the device, and then sends action requests to the device. Results of the requests are published via event messages sent by the particular service and include the values of state variables.

In one embodiment of the invention, the Ethernet port 230 on the VOIP adapter 226 is dedicated for connectivity with a storage device only. The VOIP adapter 226 uses UPnP™ technology to detect a storage device. The VOIP adapter only allows network traffic to be exchanged with the dedicated port if a storage device is detected. As example, the existing VOIP capabilities of the VT1000 Wireless Voice Gateway manufactured by Motorola, Inc. (or other similar adapters) can be combined with UPnP™ technology and other teachings of the present invention to obtain the benefits and features outlined and discussed herein.

While UPnP™ is preferred technology for the VOIP adapter to discover a network storage device, alternate protocols or standards can be used while remaining within the spirit and scope of the invention. One alternate technology similar to UPnP™ that can also be used is Bonjour (formerly known as Rendezvous). Bonjour, developed by Apple Computer, Inc. (Cupertino, Calif.), enables automatic discovery of computers, devices, and services on IP networks. Bonjour uses industry standard IP protocols to allow devices to automatically find each other without the need to enter IP addresses or configure DNS servers. Bonjour is an “open” protocol that Apple has submitted to the IETF as part of the ongoing standards-creation process. Other standards that can be used in place of UPnP™ include JINI from Sun Microsystems, Inc. and IETF's Zeroconf.

In an alternative embodiment of the invention, the storage device does not need to be directly connected to the VOIP adapter 226. According to this embodiment, the VOIP adapter 226 is capable of discovering a storage device on a local area network even if it were connected to a switch 224, hub, or other network device. This embodiment also assumes that the VOIP adapter will use UPnP™ or similar technology to detect the storage device connected to the local area network.

Once the VOIP adapter 226 “discovers” the network storage device 238, according to step 308—the VOIP adapter automatically registers the storage device with the telco's SIP registrar 207 using the registrar server address programmed in the adapter.

Registrars are specialized User Agent Servers that handle REGISTER requests. SIP devices like the VOIP adapter 226 use REGISTER requests to dynamically register their current location, and this enables them to be contacted even if plugged into different networks. Note that the registrar, proxy, redirect, and location servers are logical roles that can be played by a single device in a network; for simplicity all are combined in FIG. 1 and represented as 207.

REGISTER requests add, remove, and query bindings. A REGISTER request can add a new binding between an address-of-record and one or more contact addresses. The address-of-record is the SIP URI address associated with the storage device. The contact address corresponds to the IP address of the storage device. The registrar binds the SIP URI of the storage device and the IP address of the device in a database that can be used, for example, by proxy servers on the service provider's network to locate the storage device.

A client device can also remove previous bindings or query to determine which bindings are currently in place for an address-of-record. In accordance with the invention, the SIP compliant VOIP adapter 226 described herein is capable of handling specific REGISTER requests on behalf of a storage device 238 on the same network. If the storage device 238 is removed from the local network, the VOIP adapter 226 will automatically remove the binding for the storage device from the appropriate SIP registrar 207.

Once the storage device 238 is registered with the service provider's SIP registrar 207, the provider's database 194 is notified in step 310 to activate the respective user's ENUM-based storage service. As mentioned earlier, ENUM is a suite of protocols to unify the telephone system with the Internet by using E.164 addresses with DNS. Electronic Numbering (ENUM) is a protocol developed in the Internet Engineering Task Force (IETF), RFC 2916 (and subsequent revisions) for fetching Universal Resource Identifiers (URIs) given an E.164 number. More simply put, ENUM is a technology that enables a user to store contact information that can be accessed by another person through the use of one E.164 number. For instance, one could store a fax, voice, e-mail, instant messenger, and other addresses all in a single ENUM Naming Authority Pointer (NAPTR) DNS Resource Record. By using ENUM, another person could access all the personal contact information contained within the NAPTR. In accordance with the present invention, the address of a personal storage system is contained in the NAPTR.

E.164 is the name of the international telephone numbering plan administered by the International Telecommunication Union (ITU), which specifies the format, structure, and administrative hierarchy of telephone numbers. “E.164” refers to the ITU document that describes the structure of telephone numbers. The ITU issues country codes to sovereign nations, but administration of telephone numbers within each country is governed by that country's telecommunications regulatory agency. A fully qualified E.164 number is designated by a country code, an area or city code, and a phone number. For example, a fully qualified, E.164 number for the phone number 555-1234 in Washington, DC (area code 202) in the United States (country code 1) would be +1-202-555-1234.

In order to take advantage of ENUM, the telephone number is first assigned to a user by a telecom operator. The number can then be registered for one or more ENUM services. For example, a subscriber might wish to register an e-mail address or fax number to be associated with the same phone number. In accordance with the invention, connecting a storage device 238 to the VOIP adapter 226 automatically registers the user for the ENUM “remote storage service” that allows the user's primary E.164 number to be used as a way to target and remotely connect with a network storage device. In an alternative embodiment, registration for the remote storage service is a manual process (e.g., where a user is required to first activate the remote storage service through the service provider's web site, Interactive Voice Response (IVR) system, call center representative, or other means). However the user chooses to set up these ENUM services, the information for the registered services, including the storage service, are saved in NAPTR (Naming Authority Pointer) Resource Records. According to step 312, the NAPTR Resource Records are updated with information on the storage service. Each NAPTR record contains one or more service-specific Uniform Resource Identifiers (URIs). In accordance with the invention, a NAPTR record associated with the storage service described herein will contain a valid enumservice field associated with the storage service.

The use of ENUM presupposes the collection of these records into a central or hierarchical service. Today, there exists an issue as to ownership of these ENUM DNS zones. In other words, it has not yet been decided which entity or entities will have the right to populate the e164.arpa domain with the URIs. For purposes of illustration, the discussion herein assumes that service providers will have the right to populate a collection of resource records associated with a DNS name. The domain “e164.arpa” is being populated in order to provide the infrastructure in DNS for storage of E.164 numbers. In order to facilitate distributed operations, this domain is divided into sub-domains.

Service providers can use an ENUM provisioning tool (represented in FIG. 1 as a component of the customer database 194) to add NAPTR records to the ENUM database for user's that have enrolled in the remote storage service. The ENUM provisioning system 194 can also be used to add NAPTR records in the ENUM database corresponding to other services associated with a E.164 phone number (e.g., voice, instant messenger, etc). The service provider's database 194 enforces rules for validating users, activating services/features, and other functions.

While e164.arpa appears to have been selected as the common international DNS root for ENUM DNS entries, there is a chance that once ENUM moves beyond the trial phase in many countries, a different domain could become the new standard. As such, references to e164.arpa throughout this document are not limiting and could be replaced with another root while still remaining within the scope of the present invention.

According to the above teachings of the present invention, the VOIP adapter 226 registers the storage device 238 with the service provider's SIP proxy 207. In an alternate embodiment of the invention, the service provider's SIP proxy 207 address and the user's assigned E.164 number are configured by the user directly in the storage device 238 in order to allow the storage device to complete its own SIP registration.

In yet another embodiment, the storage device “discovers” a VOIP adapter on the network using plug-and-play technology and automatically obtains the SIP proxy address configured in the VOIP adapter. The storage device in turn uses the address to register itself with the provider's SIP proxy. The storage device could use other protocols and methods for automatically obtaining a SIP proxy address from a network device while remaining within the spirit and scope of the present invention.

According to the teachings of the present invention, an E.164 phone number is used to target a user's network connected storage system via the Internet from a remote media player device. Although a preferred embodiment, this invention is not necessarily limited to the use of E.164 phone numbers. Rather, the use of URIs and other address types that are capable of being translated to an Internet address is also possible for the purposes mentioned herein.

According to the invention a multiplicity of different media player devices are able to securely connect to the network storage device via the Internet. Media player devices may include, for example, music players (e.g., MP3 players, stereos, “whole house” audio systems, etc.), game players, video players, desktop computers, notebook computers, tablet computers, cellular phones, personal digital assistants (PDAs), satellite television receivers, cable television receivers, digital video recorders (DVRs), DVD players, VCRs, kiosks, fax machines, copiers, phones, vehicle computer/audio systems, camcorders, digital cameras, peripheral devices, mobile radios, tuning devices, display devices, global positioning system (GPS) devices, etc. These devices are able to connect to the Internet using a wireless or wireline connection, have an integrated ENUM engine in accordance with the ENUM specifications, a built-in DNS resolver, and a hardware or software-based data input mechanism.

In accordance with the invention, the ENUM engine is a standard compliant resolution tool developed based on IETF's RFC 3761. The ENUM engine provides the DNS message processing and network transport mechanisms required to translate a telephone number into a set of ENUM records. The ENUM engine supports DNSSEC and TSIG to address a variety of security issues. The ENUM engine automatically processes NAPTR record(s) in DNS wire format into application service, order, preference, and URI fields. Additionally, the ENUM engine correctly parses the NAPTR service fields and dynamically interprets POSIX Extended Regular Expressions. The ENUM engine is capable of filtering the results based on application protocol and/or service type.

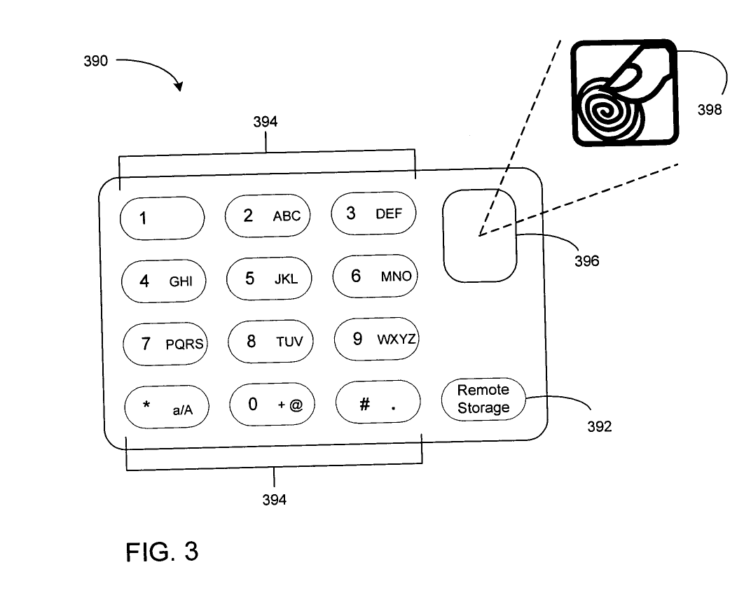

FIG. 3 is a representation of an exemplary hardware interface 390 that can be incorporated into any type of media player device or its remote control and used as a way to target and initiate connectivity with a remote storage system via the Internet according to a preferred embodiment of the present invention. The “Remote Storage” button 392 could be pressed by the user to activate a software program or routine on the device that initiates the process of connecting to a target storage device. For example, in one embodiment—pressing the “Remote Storage” button 392 may prompt the user in the device's display (not shown) for the E.164 number of the target storage device to which connectivity is desired. The user can utilize the key pad 394 to enter the E.164 number associated with the target storage device. The key pad 394 can also be used to enter PINs, passwords, or other security information needed for the remote storage device to validate the user before providing access to stored media assets or allowing other operations to be performed by the connecting user. The hardware interface 390 may also contain a biometric finger-print reader 396. The finger-print reader 396 could be utilized if the remote storage device requires biometric authentication to validate the user. Icon 398 shows an individual pressing his finger on the reader 396 according to one embodiment.

The hardware interface represented in FIG. 3 does not need to be integrated in media player devices exactly as depicted in order to remain within the spirit and scope of the invention. For example, in an alternative embodiment, the “Remote Storage” button 392 and the key pad 394 could be software-based (i.e. “soft-keys”). In yet another embodiment, the key pad 394 may be in the form of a QWERTY key board. Also, the biometric finger-print reader can be omitted altogether as PINs and/or passwords may be preferred for securing remote storage devices. Alternatively, other types of biometric components (e.g., retinal scanner, voice recognition system, etc.) could be incorporated in lieu of the finger-print reader 398. A voice recognition system could also obviate the need for manual activation of the “remote storage” feature and input of an E.164 number and related security information via a hardware/software interface.

In an alternative embodiment, an E.164 number (for a target storage device) and personal security information (e.g., PINs, passwords, biometrics, etc.) are transmitted to the media device from another device (e.g., a cellular phone) using Radio Frequency Identification (RFID). This embodiment circumvents the need for a hardware interface 390 as represented in FIG. 3, and assumes the integration of RFID technology into the media device as well as the cellular phone (or other initiating device) from which the E.164 number and security information are transmitted. Both devices may include a RFID Tag-Reader Module that is capable of functioning as a RFID tag and a RFID reader. In this embodiment, the RFID tag ID for the initiating device could be registered with the storage device and may in turn be transmitted with the E.164 number and personal security information to the media device. The media device may in turn transmit the RFID tag ID to the storage device upon establishing connectivity as part of a multi-factor authentication process. According to yet another embodiment, the same E.164 number and security information can be transmitted to the media device from another device such as a cellular phone using infra-red capability integrated into the devices. A major short-range infra-red (IR) communications network protocol, defined by the Infra-red Device Association (IrDA), is known as the IrDA standard.

The storage device can use a multi-factor authentication system that utilizes biometric data, personal identification numbers (PINs), username/passwords, answers to secret questions, software-based keys, hardware-based keys, digital certificates, token IDs (e.g., RFID), and other data.

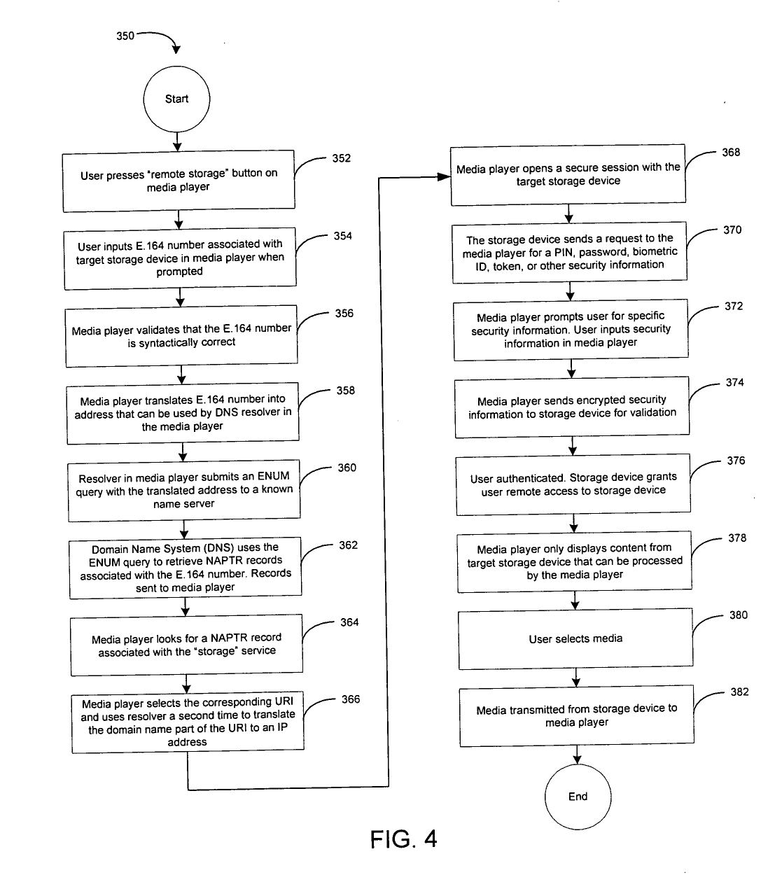

FIG. 4 is a flowchart illustrating the steps in the process of accessing a storage device from a media player device via the Internet according to a preferred embodiment of the present invention. For illustrative purposes, assume that the media device accessing the remote storage device 238 is an Internet-enabled stereo system 120 as depicted in FIG. 1. In step 352, User B presses the “remote storage” button 392 in the hardware interface 390 of the stereo system. Pressing the “remote storage” button 392 activates a software program or routine in the stereo 120 that initiates the process of connecting to a target storage device 238. A message in the media device's display prompts the user to input the phone number of the target storage device 238 to which connectivity is desired.

In step 354, the user inputs the E.164 number associated with the target storage device 238 using the media device's 120 key pad 394. In step 356, the media device validates that the E.164 number is syntactically correct. Invalid E.164 numbers (e.g., those with too few digits, those beginning with an invalid number, etc.) will be rejected by the media device; in such cases, the user would be prompted to re-enter a valid number for the target storage device. ENUM is only applicable for E.164 numbers. As an ENUM compliant device, a supported media device will only query DNS for what it believes is an E.164 number. Media devices could apply various validation routines on input E.164 numbers. An example of a validation routine may be one that restricts the input of non-domestic phone numbers (e.g., numbers from countries outside the country the user is in). Media devices may also have the ability to make basic edits in order to ensure proper formatting.

After the media device validates the E.164 number, it must translate the number into an address that can be used by a DNS resolver in the media device (step 358). Because this address is based on a complete, international telephone number (for example, +12025551234), a unique Internet address exists for every unique phone number (assuming the ENUM database is completely populated). To determine if the number and address are registered in ENUM, the telephone number is translated in the following manner by the media device in step 358:
1) All characters with the exception of the digits are removed. Example: 12025551234
2) Dots (“.”) are added between each digit. Example: 1.2.0.2.5.5.5.1.2.3.4
3) The order of the digits are reversed. Example: 4.3.2.1.5.5.5.2.0.2.1
4) The string “.e164.arpa” is appended to the end. Example: 4.3.2.1.5.5.5.2.0.2.1.e164.arpa

This domain-name is used to request Naming Authority Pointer (NAPTR) resource records which may contain the end result or, if the flags field is blank, produces new keys in the form of domain-names from the DNS. The media device 120 interacts with the domain name space through its built in resolver. The resolver has knowledge of at least one name server (likely on the service provider's network). In most implementations, the media device will automatically obtain the name server address via DHCP. The media device resolver can be configured with multiple name servers.

When the resolver processes an ENUM query it asks a known name server for the information (step 360); in return, the resolver either receives the desired information or a referral to another name server. Using these referrals, the resolver learns the identities and contents of other name servers. Note that the resolver may have to make several queries to several different external name servers to answer a particular user query, and hence the resolution of an ENUM query may involve several network accesses and an arbitrary amount of time.

The next step in the overall process of the present invention in a preferred embodiment calls for the retrieval of a NAPTR record (step 362). According to RFC 3761, the domain naming system uses the ENUM query to retrieve a NAPTR record associated with the E.164 number. The DNS response to the ENUM query contains one or more NAPTR records corresponding to the E.164 number, and each NAPTR record contains one or more service-specific Uniform Resource Identifiers (URIs).

Thus, for the example ENUM name query given above, the following NAPTR records might be received:

$ORIGIN 11 4.3.2.1.5.5.5.2.0.2.1.e164.arpa.

| | | |
|---|---|---|
| IN NAPTR 100 10 | “u” “E2U + sip” | “!\hat{ }.*$!sip:bob@telco.com!”. |
| IN NAPTR 103 10 | “u” “E2U + storage” | “!\hat{ }.*$!sips:bob@storage.telco.com!”. |

In step 364, the media device's ENUM engine will look for a NAPTR record associated with the “storage” service. The registered ‘E2U+storage’ enumservice will function as a selection mechanism for media player devices when choosing one NAPTR resource record from another. A media device, like the stereo system mentioned in the current example, can select the corresponding URI and use the resolver a second time to translate the domain name part of the URI to an IP address using the URI-specific DNS resource record as a query term (step 366). The media device can then use the full URI and appropriate service port to initiate a secure session with the remote storage device (step 368). When Telco B's proxy server 207 receives an INVITE request addressed to the storage device URI, the request will be proxied to the Contact URI or the registered storage device 238. This allows the media device 120 and the target storage device 238 to establish a secure session.

The packet format of the NAPTR RR is found in section 4 of RFC 4303. Examples of NAPTR records are shown below:

| | | | | |
|---|---|---|---|---|
| | | | | Regexp |
| Order | Pref. | Flags | Services | Replacement |

| | | | | | |
|---|---|---|---|---|---|
| IN | 100 | 10 | “u” | “E2U + | “!\hat{ }.*$!sip:bob@telco.com!” . |
| NAPTR | | | | sip” | |
| IN | 103 | 10 | “u” | “E2U + | “!\hat{ }.*$!sips:bob@storage. |
| NAPTR | | | | storage” | telco.com!” . |

NAPTR fields contain numerous components:
An Order field to specify the order in which multiple NAPTR records must be processed
A Preference field to determine the processing order when multiple records have the same order value
Service field to specify the resolution protocol and service
Flags to modify the actions of further DNS lookups
A Regular Expression to allow the query client to rephrase the original request in a DNS format
A Replacement field to define the next DNS query object

The flag “u” denotes a terminal lookup that will result in the production of a URI by the regular expression substitution specified. The “E2U+storage” specifies a service to be contacted by SIP through the use of an E.164 to URI (E2U) translation. The substitution “!ˆ.*$!sips:bob@storage.telco.com!” is then applied to the original phone number (such as +12025551234) to yield the result sips:bob@storage.telco.com, which is used to resolve SIP addresses.

The replacement string is the resultant string (“sips:bob@storage.telco.com”), which is to be used to initiate the SIP communication with the target storage device (see step 368).

Enumservice registrations must be made with the IANA. A complete registration will include the proposed “enumservice” field, the URI schemes, a functional specification, security considerations, intended usage, and any other information intended to allow for the interoperability within ENUM. Service Registration requirements are outlined in RFC 3761.

According to the teachings of the present invention, the “enumservice” field is used to represent a remote storage device or service associated with the E.164 phone number. Traditionally, the services field of a NAPTR record (as defined in RFC 3403) contains a string that is composed of two subfields: a ‘protocol’ subfield and a ‘resolution service’ subfield. ENUM in particular defines an ‘E2U’ (E.164 to URI) resolution service and a service ‘Type’ that is registered with the IANA. Note that the token “sip” that is shown as an example above is a Type registered with the IANA. The Type “storage” however, is shown for illustrative purposes. The Types have no implicit connection with the protocols or URI schemes even though they can bear the same name.

According to the teachings of the present invention the ‘E2U’ resolution service is used in conjunction with a Type that represents a storage service. For example, an ‘E2U+storage’ enumservice that indicates the presence of a network storage device connected to the Internet may be used. While the example above uses the theoretical “storage” Type, the actual label that is registered with the IANA for this purpose could be different. The service parameters including guidelines for the Type field can be found in section 2.4.2 of RFC 3761. The ‘type’ must be unique and comply with other naming requirements outlined in section 3.1.2 of RFC 3761.

The scheme of the URI that will appear in a NAPTR record using the ‘E2U+storage’ enumservice may be either ‘SIP’ or ‘SIPS’. Furthermore, the use of application protocols other than SIP and SIPs in conjunction with the ‘E2U+storage’ enumservice in the NAPTR records is also possible.

The ultimate result of this sequence of DNS queries is the specification of a protocol, an associated port address, and the IP address for a preferred server for the service.

According to a preferred embodiment, the resolved Internet address is used to establish secure real-time communication between the stereo system 120 and the storage device 238 using the Session Initiation Protocol (SIP) (for example, according to the RFC 3261 standard). SIP was developed by the IETF as part of the Internet Multimedia Conferencing Architecture, and was designed to dovetail with other Internet protocols such as Transmission Control Protocol (TCP), Transmission Layer Security (TLS), User Datagram Protocol (UDP), Internet Protocol (IP), Domain Name System (DNS), and others. SIP works with both IPv4 and IPv6.

While the use of SIP for such purposes is preferred, alternative application protocols may be used in lieu of SIP while still remaining within the spirit and scope of the present invention.

The use of SIP for establishing secure communication with a remote storage device is preferred as mobile operators and fixed line operators are moving towards a SIP-based architecture for voice and other multimedia services. It is envisioned that the use of SIP for communication with a remote storage device could leverage the same SIP registrar, proxy, redirect, and location servers used to deliver real-time interactive converged communication services (e.g., voice, video, etc.).

Connectivity between the media device 120 and target storage device 238 may use end-to-end encryption (e.g., AES, DES, Triple DES, Blowfish, Serpent, Mars, etc.).

After establishing connectivity, the storage device 238 sends a request to the media device 120 for a PIN, password, biometric ID, token or other security information (step 370). In step 372, the media device 120 processes the request and displays a message prompting the user for the specific security information. The user in turn uses the hardware interface 390 in the media device's control panel to input a PIN/password using the key pad 394, an RFID reader to input a token ID, or provide a finger-print via an integrated biometric reader 396.

In step 374, the media device 120 sends the encrypted security information to the storage device 238 for validation. If the security information is positively validated by the storage device, the user is authenticated in step 376. The storage device in turn grants the user remote access to stored media assets and the ability to upload additional media assets.

In accordance with the invention, in step 378—the media device 120 only displays content from the target storage device 238 that can be processed by the media device. In accordance with the invention, files that cannot be processed by the media device 120 are omitted from the view of files contained in the remote storage device 238. For example, in the current example, the wireless stereo system 120 is only capable of processing digital audio files (e.g., MP3, WAV, WMA, AAC, etc.). According to the invention, only supported audio files will appear in the stereo's 120 display.

The user is able to navigate through the list of directories and files contained in the remote storage device 238 using the stereo's user interface and display screen. In step 380, the user can select a specific media asset that he would like to remotely access. In the current example, the user selects multiple songs from his remote storage device 238 that he would like to listen to on User A's stereo system 120.

In step 382, the selected music playlist begins transmitting to the stereo system 120. In the current example, the selected music files are streamed over the Internet 175 to the stereo system 120. In accordance with an alternate embodiment of the invention, certain media player devices may allow media assets stored remotely to be downloaded and saved in the storage component of the media device for future processing. In accordance with the invention, users can also upload media assets to the remote storage device 238 from the media device. Users can also remotely alter media assets maintained in the storage device 238.

In accordance with the invention, the storage device 238 allows users to share files or entire folders with other Internet users. Using a permission-based system, users can control access to files and folders in the storage device 238. Users are also able to decide who can view, edit, and upload content to the storage device. Using this system, users can simply provide select individuals with their storage device's E.164 number and a unique password/PIN (optional), allowing friends or colleagues to access or upload media assets to a “public folder” in the storage device 238 remotely using the methods described above. Additionally, users can provide their E.164 number (and security information if required) to content providers (e.g., Apple iTunes, Yahoo! Music, Movielink, etc.) in order to have music, video, and other assets delivered to an associated storage device or account.

The methods described above to target and connect to a storage device using an associated E.164 number can also be employed by the user to remotely administer the storage device. In the event that the storage device is a network-connected digital video recorder (DVR) (with TiVo-like functionality), a user can use the associated DVR's E.164 number to connect to the device from an Internet-enabled device such as a cellular phone terminal in order to remotely set recording schedules and perform other administration functions.

In accordance with the invention, multiple storage devices on a local area network could be detected by a VOIP adapter 226 and registered with a service provider's SIP registrar and further linked to a single E.164 number and ENUM Naming Authority Pointer (NAPTR) DNS Resource Record.

In accordance with the invention, multiple E.164 numbers or URIs can be mapped to the same storage device or group of storage devices.

Another aspect of the invention allows users to link a storage account established with a web storage service provider (e.g., AOL/Xdrive, Inc.) to an E.164 number. According to this embodiment, the storage account and the underlying storage system register with the telco provider's SIP registrar and are further linked to an E.164 number and ENUM Naming Authority Pointer (NAPTR) DNS Resource Record.

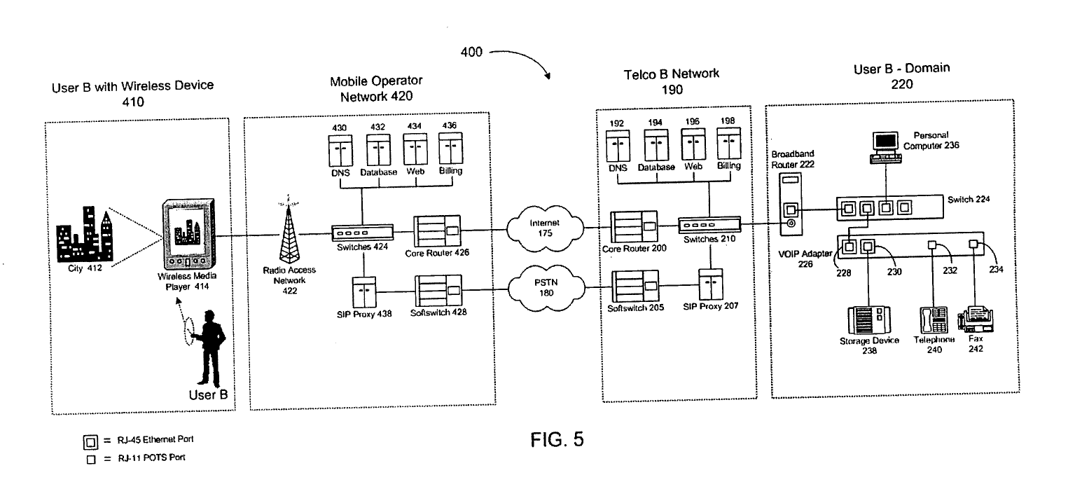

FIG. 5 is a functional diagram of a wireless media player device 414 connecting to a target storage device 238 via the Internet 175, in accordance with one embodiment of the present invention. In FIG. 5, a media device 414 wirelessly connects to the Internet 175 through a Mobile Operator Network 420. The Mobile Operator Network 420 in the illustrated example is comprised of a radio access network 422, switches 424, routers 426, softswitches 428, SIP proxy servers 438, and various functional servers (e.g., DNS 430, database 432, web 434, billing 436, etc.). The Mobile Operator Network 420 depicted in FIG. 5 and discussed herein is meant to show key components of a typical mobile operator network. In practice, different network components or configurations could be used and would not alter the invention in any way.

As used in the present example, wireless media device 414 is preferably a device that is capable of wirelessly connecting to the Internet 175 using network protocols such as GSM/GPRS, CDMA2000, W-CDMA, EDGE, HDR, 1xRTT, UMTS, IMT-2000, 802.11a, 802.11b, 802.11g, or BLUETOOTH or other relevant protocols developed hereinafter. Preferably, wireless media device 414 has a display screen and a key pad for alphanumeric and special character data input.

The media device 414 depicted in FIG. 5 is cellular phone with an integrated digital camera. The media device 414 allows a user to take still pictures or make films and store them in the device's integrated storage component itself. In accordance with the invention, the media device 414 also allows the user to transmit media (audio, video, images, etc.) captured in real-time to a remote storage device instead of storing them in the media device's own storage component. In FIG. 5, User B is filming a city scene 412 using the media device 414 which in turn is transmitting in real-time the captured media to a remote storage device 238 attached to User B's home network 220.

According to the invention, a user would first input an E.164 number for a target storage device 238 into the media device 414 in order to “attach” a remote storage system. The media device 414 would in turn submit an ENUM query with the translated address to a domain name server 430 and establish SIP connectivity with the storage device 238 using the methods illustrated in FIG. 4 and described in steps 354 to 376 above. As stated above, although the present invention is disclosed in the context of SIP, other protocols and related components may be used while still remaining within the scope and spirit of the present invention.

In the present example also, the user may be required to input a PIN, password, biometric identifier, or other security information into the wireless media device 414 in order for the storage device 238 to authenticate the user and allow media assets to be transmitted to it for storage. The wireless media device 414 could also access or download media assets from the attached storage device using the methods described earlier.

In accordance with the invention, if the wireless media device 414 temporarily loses radio connectivity to the mobile operator network 420 while capturing video footage and transmitting it to a remote storage device 238, the wireless media device 414 will automatically begin retaining the video in its integrated storage component until wireless connectivity is re-established. Upon re-establishing connectivity, the wireless media device 414 will transmit the retained video portion to the storage device 238. The storage device 238 will automatically append the new incoming video segment in sequence to the existing video footage that was previously received.

It will be understood that the components shown in FIG. 5 are merely exemplary of one embodiment of the present invention and the invention is not necessarily limited thereto.

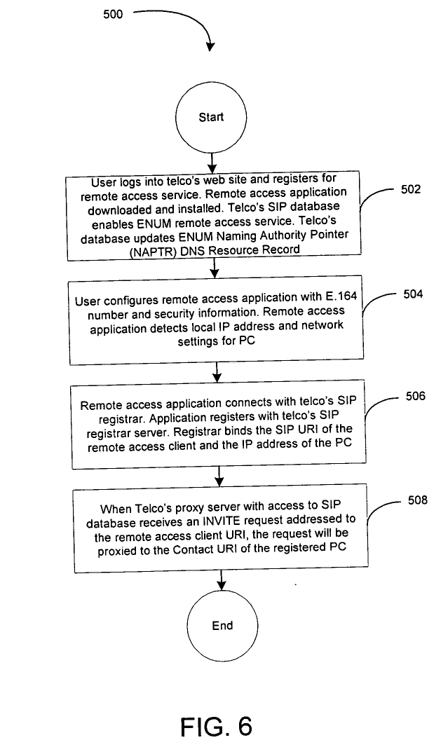

FIG. 6 is a flowchart illustrating the steps in the process of a remote access application operating on a computing device—registering itself with a service provider's SIP registrar server according to a preferred embodiment of the present invention. Once registered, the remote access application allows a user to remotely target, connect to, and manage the host device using an E.164 number or URI to which it is associated. Using the application and methods described herein, the user can control the host device remotely as if he were directly in front of it. In accordance with the invention, the client device could be a PC, cellular phone, PDA, or other type of computing device capable of connecting to the Internet.

The process outlined in FIG. 6, provides a novel method for targeting and accessing a remote computing device using an associated E.164 number or URI. The process flow refers to components in FIG. 1. The process begins with step 502, whereby User B logs into his telco provider's web site 196 using his personal computer 236 and registers for a “remote access service”. Telco B's database 194 enables the ENUM remote access service for the user's account. NAPTR Resource Records associated with the E.164 number are updated with a service-specific Uniform Resource Identifier (URI) for the remote access service. In accordance with the invention, a NAPTR record associated with the remote access service described herein will contain a valid enumservice field (such as ‘E2U+remoteaccess’) associated with the remote access service.

The scheme of the URI that will appear in a NAPTR record using the ‘E2U+remoteaccess’ enumservice may be either ‘SIP’ or ‘SIPS’. Furthermore, the use of application protocols other than SIP and SIPs in conjunction with the ‘E2U+remoteaccess’ enumservice in the NAPTR records is also possible. The enumservice field proposed herein is exemplary only as another field could be standardized upon.

After completing registration for the service, a remote access application is downloaded via his Internet connection and installed on the PC 236 that User B would like to manage remotely. The remote access application will be designed to operate on a plurality of computing platforms including those running Microsoft Windows, Linux, Sun Solaris, Apple Mac, and other operating systems.

In step 504, the remote access application detects the local IP address and network settings for the PC 236. The user configures the remote access application with his E.164 phone number and other security information (e.g., passwords, PINs, biometrics, etc.).

In step 506, the remote access application on the PC 236 connects with Telco B's SIP registrar server 207 and the user is authenticated. Telco B's SIP registrar server 207 address may have been pre-set in the “remote access” application downloaded by the user, or could have been manually input in the application by the user. The remote access client in turn completes its registration with the SIP registrar server 207 using the methods described earlier.

The registrar 207 binds the SIP URI of the PC 236 (with the remote access application) and the IP address of the PC 236 in a database that can be used, for example, by proxy servers on the service provider's network 190 to locate the device.

User B can now access his PC 236 remotely using the E.164 number as a targeting address. For the example, let us assume that User B is visiting User A in his home as shown in FIG. 1. Using a supported application such as a Java-enabled web browser operating on a client device 135, User B can input his E.164 number and any necessary security information in order to establish real-time connectivity with the host PC 236 in order to manage it remotely. In a preferred embodiment, a “remote access” button would be integrated in web browsers such as Internet Explorer, Netscape Navigator, Mozilla, Firefox, Opera, or Safari in order to allow users rapid access to their remote computing devices. In accordance with the invention, the “remote access” feature may be integrated in the web browser or added later as a software “extension” or “plug-in”. The user would be required to input into the browser a valid E.164 number for the remote computing device he would like to access. In accordance with the invention, multiple E.164 profiles could be stored in the application, allowing the user to more readily connect to different computing devices associated with different phone numbers (e.g., home, office, etc.).

In another embodiment, a “remote storage” button could be integrated in a web browser to allow for rapid access to remote storage systems. The “remote storage” button and related functionality could be integrated in the browser software or installed later as a software extension or plug-in.

The methods associated with establishing connectivity with the host PC using the E.164 number are similar to those outlined in FIG. 4 and described above. The difference in this example is that the connecting device 135 will look for a NAPTR record associated with the “remote access” service.

Finally, in step 508, when telco B's proxy server 207 receives an INVITE request addressed to the remote access client URI, the request will be proxied to the Contact URI of the registered remote access application operating on User B's PC 236. Once a SIP connection is established between the client device 135 and the host PC 236, the screen image of the remote computer 236 is transmitted and it is updated only as it changes. The data is compressed using any number of compression algorithms. For these reasons, the user does not experience the lag time that is characteristic of other remote-access solutions.

While SIP or SIPs are the preferred protocols for establishing remote connectivity between the client 135 and host PC 236, other application protocols can be used while remaining within the spirit and scope of the invention.

Connectivity between the client 135 and host PC 236 may use end-to-end encryption (e.g., AES, DES, Triple DES, Blowfish, Serpent, Mars, etc.).

Because the remote access software on the remote computer 236 initiates an outgoing connection with telco B's SIP servers 207, the technology works with existing firewalls and does not require special configuration. This method also does not compromise the integrity of firewalls that users may have on their network. The remote access application described herein could also incorporate the same NAT traversal and firewall penetration protocols/techniques incorporated in VOIP adapters.

In an alternate embodiment, the application downloaded in step 502 enables both “remote access” and “remote storage” services. As such, NAPTR Resource Records associated with the E.164 number are updated with service-specific Uniform Resource Identifiers (URIs) for the remote access service and remote storage service when a user registers for such services through the service provider's web site. The “remote storage” feature of the application allows a user to select files or entire folders in his PC hard drive that he would like to be able to access remotely using his E.164 number. Using permission-based tools within the application, users are also able to decide who can view, edit, and upload content to the PC 236 remotely using the E.164 number. The “remote storage” feature of the application described herein circumvents the need for a network storage device 238 described earlier. This application is ideal for users that have all their digital content stored in a hard drive within their PC 236. The application with the enabled “remote access” and “remote storage” feature would register itself with the SIP registrar 207 on telco B's network 190 using the methods described above. The process for accessing content on the PC 236 remotely using the associated E.164 number is outlined in FIG. 4 and discussed above.

In another embodiment the remote access and remote storage functionality described herein, could be combined in a single application with other SIP-based services such as voice-over-IP, instant messaging, video conferencing, fax service, e-mail, collaboration and various “presence” services. The remote access and remote storage functionality described could in yet another embodiment be integrated into an operating system or web browser.

While this invention has been described in terms of several preferred embodiments, there are alterations, permutations, and equivalents, which fall within the scope of this invention. It is therefore intended that the following appended claims be interpreted as including all such alterations, permutations, and equivalents as fall within the true spirit and scope of the present invention.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents

What is claimed is:

1. A method for sharing data between a media device and a remote storage: device comprising the steps of:
(a) entering addressing identification data on said media device;
(b) issuing a resolver query based upon said addressing identification data;
(c) receiving a response to said resolver query indicative of the validity of said addressing identification data;
(d) receiving an IP address associated with said addressing identification data and said remote storage device;
(e) establishing a communications link between said media device and said remote storage device using said IP address.

2. The method of claim 1 wherein said addressing identification data comprises an E.164 number.

3. The method of claim 1 further comprising the step of displaying media asset directories and files stored on said remote storage device on said media device.

4. The method of claim 1 further comprising the step of downloading data from said remote storage device to said media device.

5. The method of claim 3 further comprising the step of selecting and streaming data contained on said remote storage device to said media device.

6. The method of claim 2 further comprising the step of translating said E.164 number into a domain name prior to said step of issuing a resolver query.

7. The method of claim 6 further comprising receiving a NAPTR record associated with said E.164 number prior to said step of receiving an IP address.

8. The method of claim 1 wherein said communications link is established using a SIP protocol.

9. The method of claim 1 wherein data transmitted over said communications link is encrypted.

10. The method of claim 1 further comprising the steps of:
(f) receiving an authentication query originated by said remote storage device; and
(g) responding to said authentication query.

11. The method of claim 10 wherein said authentication query requests authentication data.

12. The method of claim 10 wherein said authentication query requests biometric data.

13. The method of claim 1 wherein said media device comprises a remote storage activation button for initiating said method for sharing data.

14. The method of claim 3 wherein said displayed files comprises only data which is processable by said media device.

15. The method of claim 1 wherein said media device comprises a personal digital assistant.

16. The method of claim 1 wherein said media device comprises an MP3 player.

17. The method of claim 1 wherein said media device comprises a stereo player.

18. The method of claim 1 wherein said media device comprises a digital video recorder.

19. The method of claim 1 wherein said media device comprises a wireless telephone.

20. The method of claim 1 wherein said media device comprises a personal computer.

21. The method of claim 1 wherein said step of entering addressing identification data comprises receiving information from a device which is remote to said media device via RFID communication.

22. The method of claim 21 wherein said received information comprises an E.164 number.

23. The method of claim 2 wherein said E.164 number is mapped to a plurality of remote storage devices.

24. The method of claim 2 wherein a plurality of E.164 numbers are mapped to a single remote storage device.

25. The method of claim 7 further comprising the step of selecting a URI specific to said remote storage device based upon an enumservice field.

26. The method of claim 1 wherein said remote storage device communicates with said media device through a VOIP adapter.

27. The method of claim 1 wherein said remote storage device is automatically recognized by said VOIP adapter.

28. The method of claim 26 wherein said remote storage device automatically detects said VOIP adapter and obtains a SIP proxy address from said VOIP adapter.

29. The method of claim 28 wherein said automatic recognition is accomplished via plug-and-play functionality.

30. The method of claim 27 wherein said VOIP adapter automatically registers said storage device with a SIP proxy.

31. A communications network for establishing and conducting communication between a media device and a remote storage device comprising:
a VOIP adapter in communication with said remote storage device;
a SIP proxy, said SIP proxy storing addressing information associated with said VOIP adapter and said remote storage device;
a first network switch in communication with said media device; and
a second network switch in communication with said VOIP adapter.

32. The communications network of claim 31 wherein said media device further comprises an interface for supplying addressing data, said addressing data being translatable into an IP address associated with said remote storage device.

33. The communications network of claim 31 wherein said media device further comprises an interface for supplying authentication data, said authentication data being used to authenticate said user of the media device prior to initiation of a data exchange between said remote storage device and said media device.

34. The communications network of claim 31 wherein said authentication data comprises biometric data.

35. The communications network of claim 31 wherein said addressing data comprises an E.164 number associated with said network storage device.

36. The communications network of claim 31 wherein said communication is established using a SIP protocol.

37. The communications network of claim 31 wherein said VOIP adapter automatically detects said remote storage device using plug-and-play functionality.

38. The communications network of claim 35 wherein said media device further comprises an ENUM engine which translates said E.164 number into an Internet Protocol (IP) address.

39. The communications network of claim 31 wherein said VOIP adapter comprises a data port dedicated to connecting with said network storage device.

40. The communications network of claim 31 wherein said media device comprises an MP3 player.

41. The communications network of claim 31 wherein said media device comprises a stereo player.

42. The communications network of claim 31 wherein said media device comprises a digital video recorder.

43. The communications network of claim 31 wherein said media device comprises a wireless telephone.

44. The communications network of claim 31 wherein said media device comprises a personal computer.

45. The communications network of claim 31 wherein said remote storage device is connected to said second network switch via a local area network.

46. The communications network of claim 31 wherein said remote storage device comprises a hard drive associated with a personal computer.

47. The communications network of claim 45 further comprising a remote access application which is stored on said personal computer.

48. The communications network of claim 31 wherein said media device further comprises storage for storing data downloaded from said remote storage device.

49. The communications network of claim 31 wherein said media device comprises a first personal computer and said remote storage device comprises a second personal computer.

50. The communications network of claim 49 wherein an E.164 number is used as a targeting address for said second personal computer.

51. The communications network of claim 49 wherein said first personal computer comprises a browser with a remote access activation icon.
